(19) United States
(12) Patent Application Publication
(10) Pub. No.: US 2004/0153303 A1
(43) Pub. Date: Aug. 5, 2004

(54) Efficient process for time dependent network model in an energy market simulation system

(76) Inventors: Le Tang, Cary, NC (US); Xiaoming Feng, Apex, NC (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/744,386

(22) Filed: Dec. 23, 2003

Related U.S. Application Data
(60) Provisional application No. 60/437,451, filed on Dec. 30, 2002.

(51) Int. Cl. G06F 17/50

(52) U.S. Cl. 703/18

(57) ABSTRACT

A method and system for efficiently simulating an electric power transmission network is disclosed. In the method, a parameterized value is assigned to an element in the network that is present during any time interval of a simulation test period. If an element in the network has changed from a preceding time interval, the network of the preceding time interval is updated by changing the parameterized value for the changed element, and the updated network is simulated. If any element in the network has not changed from the network of the preceding time interval, the network is simulated based on the network of the preceding time interval.

### RELATED APPLICATIONS

This application claims the benefit of U.S. Application No. 60/437,451, filed Dec. 30, 2002, titled “Efficient Process For Time Dependent Network Model In An Energy Market Simulation System,” the disclosure of which is hereby incorporated by reference in its entirety.

### FIELD OF THE INVENTION

The invention relates to the field of electric power transmission. More specifically, the invention relates to the computer simulation of an electrical power market under the constraints of a transmission system.

### BACKGROUND OF THE INVENTION

The 1992 Federal Energy Policy Act served to enhance competition in the electric energy sector by providing open access to the United States' electricity transmission network. Other countries soon followed by deregulating and privatizing their electric energy services. As a result of this deregulation, independent power providers (IPP), also known as merchant power plants (MPP), began building power generation sources to sell wholesale power on a competitive basis to utilities and power marketers. The utilities and power marketers then transmit the low-cost power to their customers. Unlike traditional power plants that serve a defined area, MPPs may generate their power from and sell their power to nearly any location.

In order to deliver their power to utilities and power marketers, the MPPs must be connected to an electricity transmission network, often referred to as the “grid.” The grid is a network of high-voltage transmission lines that connect producers of electric power to the end customer. In the United States, there are ten regional networks or grids (e.g., Mid-America Interconnected Network, Western System Coordinating Council, etc.) collectively serving the power needs in the United States.

As a result of industry deregulation, there has been a corresponding decentralization of power generating sources, and an increase in the number of providers. This decentralization means there are more transmission line projects in more locations, where in the past there were larger, well-defined projects in fewer locations. Therefore, while deregulation has served to reduce the cost of electric power to the consumer, it also has complicated certain business processes in the power industry.

To better accomplish such business processes, the power industry uses simulation software to simulate electrical power generation networks and markets. Such software enables a power generator, utility, power marketer or the like to predict the behavior of the network, as well as any effects of one or more changes to the network. For example, a utility may plan to remove a transmission line from service for maintenance, and as a result other lines will have to transmit additional power to compensate. How such compensation occurs is calculated, for example, by determining the generation shift factor (GSF) effect that results from removing the transmission line from service. The utility can view the predicted changes to the network and can plan accordingly.

In addition, changing market forces (such as the difference in price between two or more MPPs) may need to be accounted for so the software user will be able to determine a fiscally optimal power and/or network configuration. For example, a power consumer or marketer will want to purchase as much less-expensive power as possible. However, transmission lines may become overburdened if all of the power consumer's power comes from such a less-expensive source. Thus, the power consumer can use the modeling software to determine a balancing point of purchasing as much of the less-expensive power as possible while remaining within network operational limits. In many of these and other applications of power network simulation software, a simulation software user typically wishes to simulate the network over a period of time. During such a period of time (herein referred to as a “simulation test period” for clarity), the network to be simulated may undergo one or more changes to elements, market forces and/or the like.

Conventional simulation software, however, has a significant shortcoming when simulating a network that changes during a simulation test period. Conventional software typically assumes a static network, which yields inaccurate results when the network to be simulated changes over time. Some conventional simulation software attempts to overcome this limitation by recalculating the entire network for every change that occurs during the test period. Such a method is computationally intense, because the network is typically very large and difficult to model. As a result, the network simulation takes more time to compute the new network model than is otherwise necessary. Therefore, what is needed is a method for recalculating a network in a manner that enables less computationally-intense, and therefore faster, calculations. More particularly, what is needed is an accurate and efficient network simulation method that is able to incrementally update the simulated power transmission network.

### SUMMARY OF THE INVENTION

In light of the foregoing limitations and drawbacks, a method and system for efficiently simulating an electric power transmission network is presented. In the method, a parameterized value is assigned to an element in the network that is present during any time interval of a simulation test period. If an element in the network has changed from a preceding time interval, the network of the preceding time interval is updated by changing the parameterized value for the changed element, and the updated network is simulated. If any element in the network has not changed from the network of the preceding time interval, the network is simulated based on the network of the preceding time interval.

### BRIEF DESCRIPTION OF THE DRAWINGS

Other features of the invention are further apparent from the following detailed description of the embodiments of the invention taken in conjunction with the accompanying drawings, of which:

FIG. 1 is a block diagram of an electric power transmission system;

FIG. 2 is a graphical depiction of a power transmission network for which aspects fo the present invention may be implemented;

FIG. 3 is a graphical depiction of an exemplary simulation test period during which aspects of the present invention may be implemented; and

FIG. 4 is a flow chart illustrating a method of simulating a power transmission network according to one embodiment of the present invention.

### DETAILED DESCRIPTION OF ILLUSTRATIVE EMBODIMENTS

Overview of Electric Power Transmission System

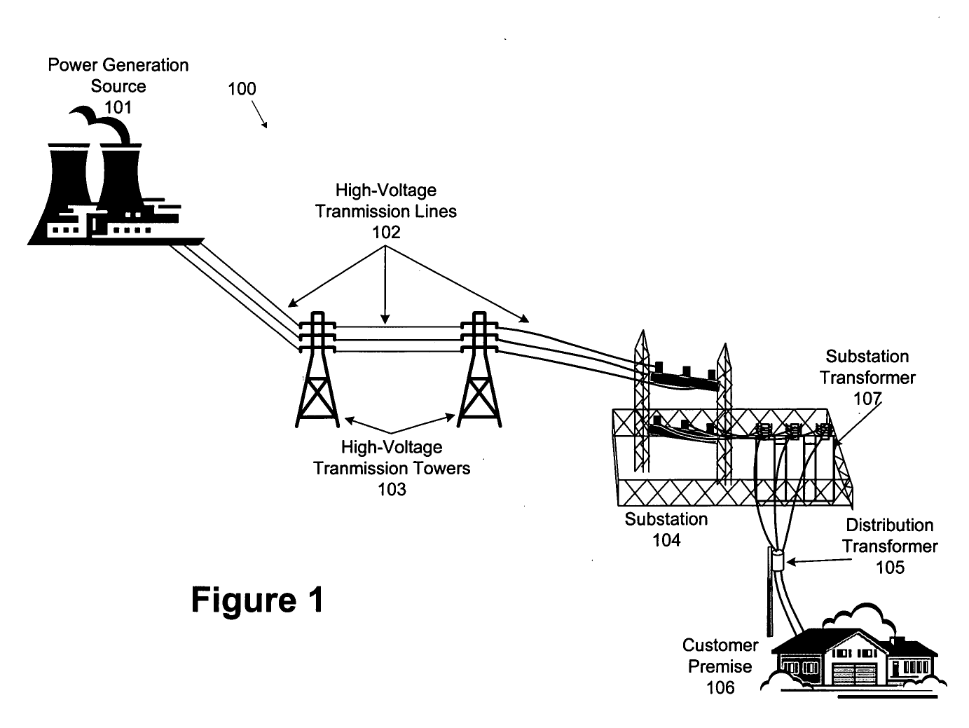

FIG. 1 is a block diagram of an electric power transmission system 100. Generally, an electric power transmission system 100 has three major components: the generating facilities that produce the electric power, the transmission network that carries the electric power from the generation facilities to the distribution points, and the distribution system that delivers the electric power to the consumer. As shown in FIG. 1, a power generation source 101 is a facility that produces electric power. The power generation source 101 includes a generator (not shown in FIG. 1 for clarity) that creates the electrical power. The generator may be, for example, a gas turbine or a steam turbine operated by burning coal, oil, natural gas, or a nuclear reactor. In each case, the power generation source 101 provides a three-phase alternating current (AC) power. The AC power typically has a voltage of a few tens of thousands of volts.

A transmission substation (not shown in FIG. 1 for clarity) then increases the voltage from power generation source 101 to high-voltage levels for long distance transmission on high-voltage transmission lines 102. Although the high-voltage transmission levels have increased with improvements in technology, typical voltages found on high-voltage transmission lines 102 range from 69-800 kilovolts (kV). High-voltage transmission lines 102 are supported by high-voltage transmission towers 103. High-voltage transmission towers 103 are large metal support structures attached to the earth, so as to provide a ground potential to system 100. High-voltage transmission lines 102 carry the electric power from power generation source 101 to a substation 104. A typical maximum distance between power generation source 101 and substation 104 is approximately three hundred miles.

Generally, substations act as a distribution point in the system 100 and a point at which voltages are stepped-down to reduced voltage levels. Substation 104 converts the power on high-voltage transmission lines 102 from transmission voltage levels to distribution voltage levels. In particular, substation 104 uses transformers 107 that step down the transmission voltages from the 69-800 kV level to distribution voltages that typically are less than 35 kV. In addition, substation 104 may include an electrical bus (not shown) that serves to route the distribution level power in multiple directions. Furthermore, substation 104 often includes circuit breakers and switches (not shown) that permit substation 104 to be disconnected from high-voltage transmission lines 102 when a fault occurs on the lines.

The substation 104 typically is connected to a distribution transformer 105. The distribution transformer 105 may be an aerial transformer located atop a telephone or electric pole, a pad-mounted transformer located on the ground, or the like. Voltage levels between the substation 104 and the distribution transformer 105 typically are less than 10 kV. The distribution transformer 105 steps-down the voltage to voltage levels required by a customer premise 106, for example. Such voltages typically range from 240 V to 440 V. Also, the distribution transformer 105 may function to distribute one, two or all three phases of the three-phase current to the customer premise 106, depending upon the demands of the user.

High-voltage transmission lines 102 between power generation source 101 and substation 104 typically are referred to as the “grid.” When new power generation sources are added, or when existing power generation sources require new and/or upgraded connections, a transmission line must be run from the power generation source to the grid. In addition, engineering analysis must be performed regarding the voltage level rating of the transmission line, the path of the transmission line, the interconnection points on the transmission line, power deliverability, and power stability, for example. Other changes to the grid may also require analysis such as, for example, temporary or permanent removal of transmission lines, plant shutdowns, and the like.

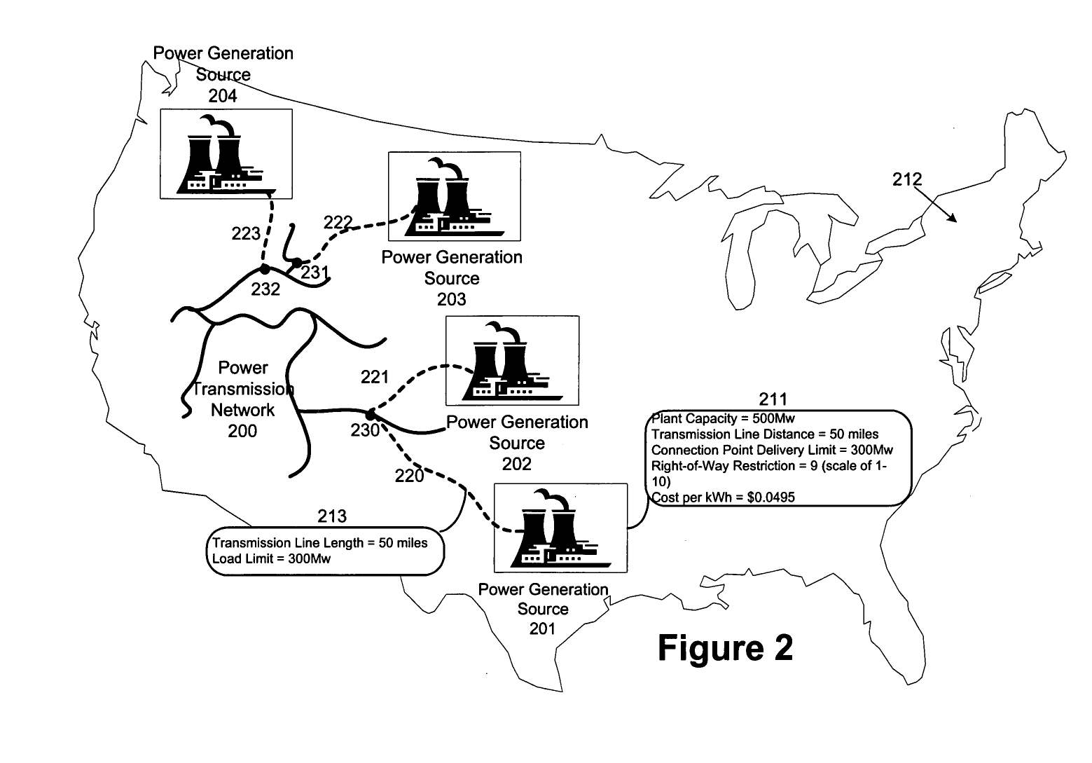

Turning now to FIG. 2, an exemplary power transmission network in which aspects of the invention may be implemented is shown. It will be appreciated that FIG. 2 illustrates a higher-level view of the system illustrated in FIG. 1. In the illustrated power transmission network 200, a depiction of all power generation sources 201-204 that require a connection to the power transmission network 200 can be seen. In addition, a path for the connection from each of the power generation sources 201-204 to the power transmission network 200 is illustrated.

As can be seen in FIG. 2, a power generation source 201 is coupled to the power transmission network 200 via a transmission line 220 at interconnection point 230. Power generation source 202 is coupled to power transmission network 200 via transmission line 221 at interconnection point 230. Power generation source 203 is coupled to power transmission network 200 over transmission line 222 at interconnection point 231. Power generation source 204 is coupled to power transmission network 200 over transmission line 223 at interconnection point 232. For ease of understanding the geographic layout of the power transmission network 200, power generation sources 201-204 and power transmission network 200 are laid over a map of the United States 212. Although a network within the United States 312 is depicted in FIG. 2, it should be appreciated that any region's power network may be used in connection with an embodiment of the present invention. For example, a network of another country (e.g., France), or a network of a particular geographical region (e.g., the Midwest U.S.), or the like, may be used in connection with such an embodiment.

It will be appreciated that each element within FIG. 2 has certain characteristics that, in one embodiment of the present invention, are accounted for in order to perform a network simulation. Box 211 illustrates an exemplary collection of such data that may be input into network simulation software to model power generation source 201. In box 211, the plant capacity is seen to be 500 MW, the transmission line distance is 50 miles, the connection point delivery limit is 300 MW, the right-of-way restriction is 9, and the cost per kWh charged by the power generator associated with the power generation source 201 is $0.0495. It should be appreciated that any type or amount of such information may be used for purposes of simulating the network 200.

As an additional example, box 213 contains exemplary data regarding transmission line 220. In box 213, the length of the line segment is 50 miles, and the load limit is 300 MW. It will further be appreciated that each element to be modeled by network simulation software should have some sort of data associated with it that will enable modeling. The data that is shown in boxes 211 and 213 can be acquired by, for example, manual input of such data, automatic input, electronic retrieval of such data, and the like.

Thus, the data as shown above in boxes 211 and 213 can be input into network simulation software for purposes of simulating the operation of electricity markets. Such simulation software may be utilized in any number of ways. For example, software on a computer-readable medium may have computer-executable instructions that perform a simulation method according to one embodiment of the present invention. Such a computer-readable medium may be found on a single stand-alone desktop computer, for example. Alternatively, the method may be performed by an active service provider (ASP) application accessible to multiple users via a data network, such as the Internet. Data management, simulation, and/or the visual rendering of the simulation results can be accomplished by computer software such as, for example, GridView, available from ABB Inc. GridView is a market simulation software application that mimics the operation of independent system operators (ISO) and the market interaction between spatially distributed supply and demand under various operational constraints of the electric power transmission system.

Power Network Simulation

In the discussion to follow, it is assumed that methods and systems for modeling and simulating an electrical power transmission system, as well as the market forces present in such a system, should be well-known to those of skill in the art and, accordingly, such matters are not discussed herein for clarity. It is also assumed that specifics relating to power transmission data, such as that discussed above in connection with FIG. 2, should be known to those of skill in the art and are therefore not discussed in any further detail.

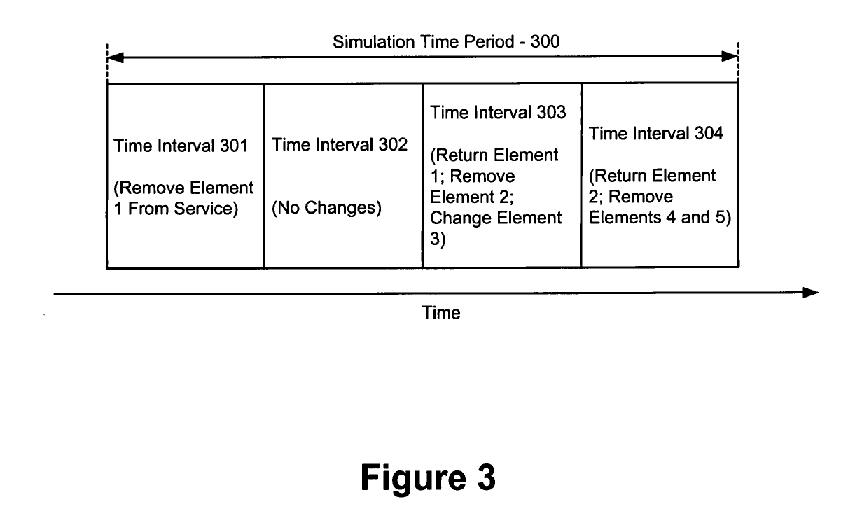

Referring now to FIG. 3, a graphical depiction of an exemplary simulation test period for which aspects of the present invention may be implemented is illustrated. In FIG. 3, a simulation test period 300 is shown. Simulation test period 300 comprises four time intervals 301-304. It will be appreciated that any number of time intervals 310-304 may be present in any given simulation test period 300. In addition, while FIG. 3 represents each time interval 301-304 as being of equal length, each time interval 301-304 may be of any duration. In some embodiments, the time intervals last for a predetermined amount of time. For example, a time interval may be 15 minutes, 1 hour, 1 day, or the like. The depiction of FIG. 3, therefore, represents the time over which a particular network will be modeled by network simulation software. It will be appreciated that for any given simulation time period 300 (which can be any duration of time), elements within the network (e.g., transmission lines, power generating plants, etc.) may change, be added, deleted, and so forth.

Thus, at time interval 301, it can be seen that element 1 has been removed from service. At time interval 302, no changes to the network have taken place. At time interval 303, element 1 has been returned to service, element 2 has been removed from service, and a characteristic of element 3 has been changed. Finally, at time interval 304, element 2 has been returned to service and elements 4 and 5 have been removed. As discussed above, conventional network simulation software either assumes the network has a static configuration throughout the simulation test period 300, or recalculates the entire network for each time interval 301-304. It can readily be seen that assuming a static network for the simulation test period 300 illustrated in FIG. 3 will yield inaccurate results, as some elements have been removed and replaced, an element has been changed, and yet others have been removed and left out of the network. Recalculating the entire network for each time interval 301-304 requires a great deal of computing power. For example, at least one characteristic for every element, such as those discussed above in connection with boxes 211 and 213 of FIG. 2, may be placed into one or more matrixes and resolved. It will be appreciated that modeling a large-scale network such as a network spanning the entire United States will take a great deal of computing power and time. Furthermore, the complete recalculation required by conventional software is due to such conventional software's treatment of an element as a “binary” value—either the element is present in the network or it is not. As a result, a new matrix (or matrixes) needs to be generated for every time interval because changing the number of elements necessarily changes the size of the matrix.

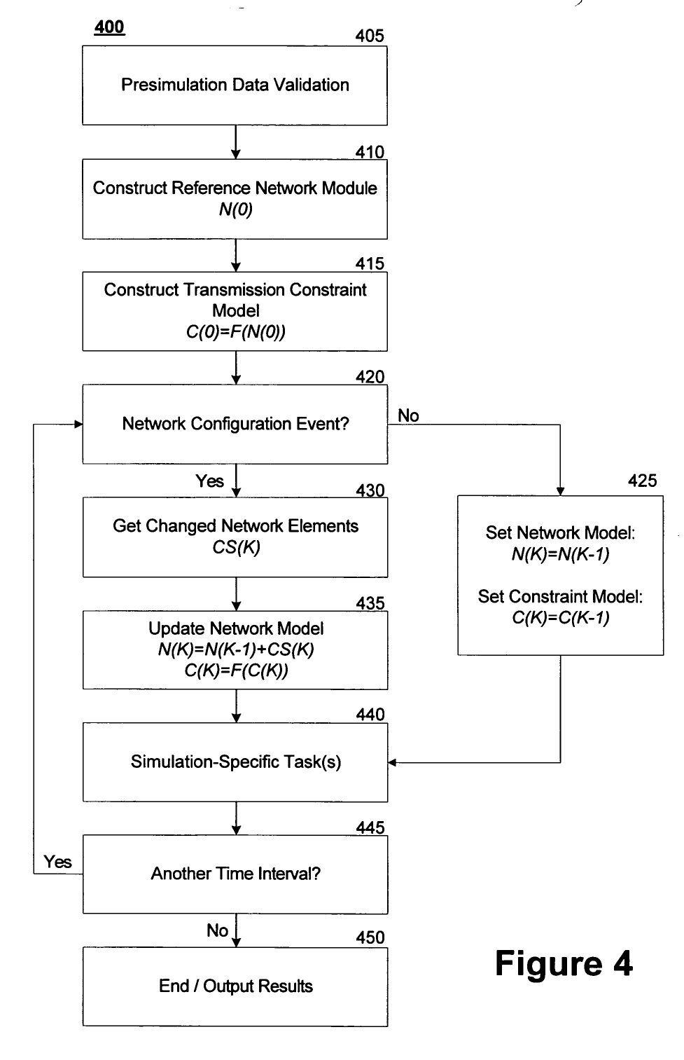

Accordingly, and turning now to FIG. 4, a flowchart illustrating a method 400 of efficiently simulating a power transmission network according to one embodiment of the present invention is shown. It will be appreciated in the discussion that follows in connection with FIG. 4 that the method accounts for the changing elements of a network to be simulated, thereby yielding more accurate results. In addition, only the aspects of the network that have changed for any particular time interval such as, for example, time intervals 301-304 as discussed above in connection with FIG. 3, will be recalculated, thereby reducing the computing power and time required. An embodiment of the present invention may be implemented an integrated part of any type of network simulation software. Alternatively, an embodiment of the present invention may be implemented as a program module or a stand-alone program to supplement the operations of network simulation software.

In the method 400, a power transmission network such as, for example, the network illustrated in FIG. 2 is simulated to enable a user such as, for example, a power generator or marketer, to analyze changes in the network to make business and engineering decisions. As noted above in connection with FIG. 2, a variety of factors may be accounted for in the simulation, many of which may be economically-based. As a result, educated business and engineering decisions can be made because the effects of such decisions can be known accurately and in advance.

At step 405, presimulation data validation takes place. In step 405, data that is to be used to model the network is verified against known values and the like. For example, in one embodiment a network topology is verified to ensure connectivity for a proper simulation. As noted above in connection with FIG. 2, the data used for step 405 may be acquired in any manner.

At step 410, a reference network model, N(0), is constructed. Importantly, this reference network model includes each element that will be present in the network during any time interval of the simulation test period. For example, a simulation test period contains four time intervals, and a particular element, such as a transmission line, is only present in the fourth time interval. Such a situation can occur when a transmission line is first placed in service, or is placed back in service after repairs, or the like. When creating the reference network model, the method 400 according to one embodiment of the present invention includes the element in the reference network for all time intervals. In one embodiment, the numerical values of N(0) are initialized such that N(0) corresponds to the network configuration in the first time interval of the simulation period. It will be appreciated that in other embodiments the reference network model may be a purely conceptual construction, and may not correspond to any actual system configuration at any time during the simulation test period. It will also be appreciated that the presence of the element in time intervals where such element is not in operation requires some method of effectively removing the element while retaining its information regarding operating characteristics, so that the element may be modeled when the method 400 is simulating the network over a time period where the element is in service.

At step 415, an embodiment of the present invention accomplishes this task by using parameterized values for all elements when constructing a transmission constraint model, C(0), from the reference network. The transmission constraint model includes operating and other characteristics (e.g., thermal constraints, interface constraints, simultaneous constrains, economic factors, etc.) for each element in the reference network, hence the expression of the constraint model as a function of the reference network model, C(0)=F(N(0). In a method according to an embodiment of the present invention, instead of simply entering an operating characteristic of an element into the equations (e.g., a matrix or the like) necessary to simulate the network as a numerical value (e.g., 650 Ω), the method 400 enters the operating characteristic as a coefficient and variable (e.g., 650b Ω). By doing so, the method can easily modify the variable (b in the above example) to effectively remove the element from the network if desired. For example, the impedance of the element may be raised (by way of the variable) to such a large value that the element is effectively open-circuited.

It will be appreciated that the use of parameterized values for all possible elements enables the method 400 to reduce the computational complexity, and time, involved with simulating a network that changes several times during a simulation test period. Instead of re-computing the entire network, as is conventional, an embodiment of the present invention such as method 400 simply changes the variable associated with the changed characteristic(s) of the changed element(s). In such a manner, the computations (typically a very large matrix with many values contained therein, as noted above) can be kept largely the same as only a small percentage of the elements are usually affected by the configuration changes and therefore need to be updated. Thus, improved speed results as the method 400 only has to resolve a few selected rows and columns of the matrix as a result of the changes since the previous time interval, rather than having to recreate the matrix itself, which is very computationally intensive. As will be discussed below in connection with steps 420-425, if no changes have been made to the network since the previous time interval, the network of the previous time interval can be used for the purposes of the simulation.

At step 420, a determination is made as to whether a network configuration event has taken place from the previous time interval. A network configuration event can be, for example, a removal or addition of an element, or a change in one or more operating or economic characteristics. If no such configuration event has taken place, the method 400 proceeds to step 425. At step 425, the network model is set to the previous time interval's network model, as indicated by the exemplary expression N(K)=N(K−1), where N(K) is the network model for a current time interval, and N(K−1) is the network model for the immediately preceding network model. In addition, the constraint model is also set to the previous time interval's constraint model, as indicated by the exemplary expression C(K)=C(K−1), where C(K) is the constraint model for a current time interval, and C(K−1) is the constraint model for the immediately preceding time interval. It will be appreciated that step 425's use of a previous time interval's network and constraint models further reduces the computations necessary to generate a simulation of the network. It will also be appreciated that if there is no previous time interval (i.e., the current time interval is the first time interval), then the reference network and/or network constraint model can be used.

If, at step 420, the determination was that a network configuration event had taken place, then the method 400 proceeds to step 430. At step 430, the changed network elements are collected and a changed network element set, CS(K), is created. CS(K) represents the difference between two network models at consecutive time intervals. As may be appreciated, any method of creating such a set that is consistent with the simulation software in which an embodiment of the present invention is implemented is also consistent with such an embodiment. Then, at step 435, the network model is updated with the changed network element set as represented by the exemplary expression N(K)=N(K−1)+CS(K). Likewise, the constraint model is updated, as represented by the exemplary expression C(K)=F(C(K)).

Any method of implementing the above updating is equally consistent with an embodiment of the present invention. For example, in one embodiment, and as noted above, a matrix containing parameterized values for every element that is in the network at any point during the simulation test period is updated by adjusting the variable(s) associated with the value(s) representing the element. Then, the matrix is resolved to determine the characteristics for the updated network.

At step 440, simulation-specific tasks may take place according to the simulation software being used in connection with an embodiment of the present invention such as, for example, GridView, the above-mentioned market simulation software by ABB, Inc. At step 445, a determination is made as to whether another time interval during the simulation test period is to be calculated. If so, the method 400 returns to the determination of step 420. If there are no further time intervals, then the method 400 proceeds to step 450. At step 450, the method 400 ends. Alternatively, at step 450 the method 400 may output data to another component of the simulation software, to a storage or display device, to another software program, or the like. As may be appreciated, the data may contain simulation results or other data that may be relevant to a simulation software user for planning or organizational purposes.

Thus, an efficient process for time-dependent network simulation in an energy market simulation system is disclosed. While the invention has been particularly shown and described with reference to the embodiments thereof, it will be understood by those skilled in the art that the invention is not limited to the embodiments specifically disclosed herein. Those skilled in the art will appreciate that various changes and adaptations of the invention may be made in the form and details of these embodiments without departing from the true spirit and scope of the invention as defined by the following claims.

What is claimed:

1. A method of simulating an electric power transmission network, comprising:
assigning a parameterized value to an element in the network that is present during any time interval of a simulation test period;
if an element in the network has changed from a preceding time interval, updating the network of the preceding time interval by changing the parameterized value for the changed element; and
simulating the updated network.

2. The method of claim 1, wherein the preceding time interval comprises an immediately preceding time interval.

3. The method of claim 1, further comprising simulating the network based on the network of the preceding time interval if any element in the network has not changed from the network of the preceding time interval.

4. The method of claim 1, further comprising assigning an operating constraint to the element in the network that is present during any time interval of a simulation test period.

5. The method of claim 1, further comprising verifying a transmission network topology to ensure element connectivity during the simulation test period.

6. The method of claim 1, wherein changing of the parameterized value reflects a change in impedance.

7. The method of claim 6, wherein changing the parameterized value reflects an increase in impedance to a value sufficient to effectively remove the element from the network.

8. The method of claim 6, wherein changing the parameterized value reflects a decrease in the impedance of the changed element to effectively place the element in service.

9. The method of claim 1, wherein updating the network comprises accounting for a generation shift factor effect resulting from the changed element.

10. The method of claim 1, wherein the element is a transmission line.

11. The method of claim 1, wherein the changed element is related to a cost of power being transmitted across the network.

12. A method of simulating a power transmission network, comprising:
constructing a network reference model by including a parameterized value for an element that is present in the network during a time interval of the simulation test period;
for each time interval:
if an element in the network has changed from a preceding time interval:
acquiring at least one changed element to create a changed element set;
updating the network of the immediately preceding time interval by way of a branch parameter change for each changed element in the changed element set; and
simulating the updated network.

13. The method of claim 12, further comprising building a reference transmission constraint model, wherein the model incorporates at least one operating constraint for each element in the network.

14. The method of claim 12, further comprising simulating the network based on the network of the immediately preceding time interval if any element in the network has not changed from an immediately preceding time interval.

15. The method of claim 12, further comprising verifying a transmission network topology to ensure connectivity during the simulation test period.

16. The method of claim 12, further comprising simulating the network based on the reference transmission constraint model if any element in the network is unchanged from the reference transmission constraint model.

17. The method of claim 12, wherein if an element in the network has changed from the reference transmission constraint model:
acquiring at least one changed element to create a changed element set;
updating the reference transmission constraint model by way of a branch parameter change for each changed element in the changed element set; and
simulating the network based on the updated network.

18. The method of claim 12, wherein the branch parameter change reflects a change in impedance of the changed element.

19. The method of claim 18, wherein the branch parameter change reflects an increase in the impedance of the changed element to a value sufficient to effectively remove the element from the network.

20. The method of claim 18, wherein the branch parameter change reflects a decrease in the impedance of the changed element to effectively place the element in service.

21. The method of claim 12, wherein updating the network accounts for a generation shift factor effect resulting from the changed element.

22. The method of claim 12, wherein the element is a transmission line.

23. The method of claim 12, wherein the change in status of the element is related to a cost of power being transmitted across the network.

24. The method of claim 12, wherein verifying a transmission network topology further comprises determining connectivity of each element for each time interval.

25. The method of claim 12, wherein constructing a network reference model results in a conceptual construction.

26. The method of claim 12, wherein building a reference transmission constraint model further comprises accounting for thermal constraints.

27. The method of claim 12, wherein building a reference transmission constraint model further comprises accounting for interface constraints.

28. The method of claim 12, wherein building a reference transmission constraint model further comprises accounting for simultaneous constraints.

29. An electric power transmission network simulator, comprising:
a first mechanism for constructing a network reference model having a parameterized value for an element in the network during at least one time interval of a simulation test period;
a second mechanism that, if an element in the network has changed from a preceding time interval, updates the network of the preceding time interval by changing the parameterized value for the changed element, and simulates the network based on the updated network.

30. The simulator of claim 29, wherein the second mechanism simulates the network based on the network of a preceding time interval if no element in the network has changed from the preceding time interval.

31. The simulator of claim 29, wherein the first mechanism further builds a reference transmission constraint model, wherein the model incorporates at least one operating constraint for the element.

32. The simulator of claim 29, wherein the first mechanism checks a transmission network topology to ensure element connectivity during the simulation test period.

33. The simulator of claim 29, wherein the first and second mechanisms are the same mechanism.

34. The simulator of claim 29, wherein the element is a transmission line.

35. A computer-readable medium having computer-readable instructions for performing a method for simulating an electric power transmission network, the method comprising:
assigning a parameterized value to an element in the network that is present during any time interval of a simulation test period;
if an element in the network has changed from a preceding time interval, updating the network of the preceding time interval by changing the parameterized value for the changed element; and
simulating the updated network.

36. The computer-readable medium of claim 35, wherein the method further comprises simulating the network based on the network of the preceding time interval if any element in the network has not changed from the network of the preceding time interval.

37. The computer-readable medium of claim 35, further comprising assigning an operating constraint to the element in the network that is present during any time interval of a simulation test period.

38. A computer-readable medium having computer-readable instructions for performing a method for simulating a power transmission network, the method comprising:
constructing a network reference model by including a parameterized value for an element that is present in the network during a time interval of the simulation test period;
for each time interval:
if an element in the network has changed from a preceding time interval:
acquiring at least one changed element to create a changed element set;
updating the network of the immediately preceding time interval by way of a branch parameter change for each changed element in the changed element set; and
simulating the updated network.

39. The computer-readable medium of claim 38, further comprising building a reference transmission constraint model, wherein the model incorporates at least one operating constraint for each element in the network.

40. The computer-readable medium of claim 38, further comprising simulating the network based on the network of the immediately preceding time interval if any element in the network has not changed from an immediately preceding time interval.

41. The computer-readable medium of claim 38, further comprising simulating the network based on the reference transmission constraint model if any element in the network is unchanged from the reference transmission constraint model.

42. The computer-readable medium of claim 38, wherein if an element in the network has changed from the reference transmission constraint model:
acquiring at least one changed element to create a changed element set;
updating the reference transmission constraint model by way of a branch parameter change for each changed element in the changed element set; and
simulating the network based on the updated network.

43. The computer-readable medium of claim 38, wherein the element is a transmission line.

44. The computer-readable medium of claim 38, wherein the change in status of the element is related to a cost of power being transmitted across the network.
